(19) United States
(12) Patent Application Publication
(10) Pub. No.: US 2013/0286185 A1
(43) Pub. Date: Oct. 31, 2013

(54) REAL TIME MONITORING DEVICE FOR MONITORING PROCESS OF PROCESSING WORKPIECE

(71) Applicant: PO-CHOU CHEN, Tu-Cheng (TW)

(72) Inventor: PO-CHOU CHEN, Tu-Cheng (TW)

(21) Appl. No.: 13/649,598

(22) Filed: Oct. 11, 2012

(30) Foreign Application Priority Data
Apr. 27, 2012 (TW) 101115099

(51) Int. Cl. H04N 7/18

(52) U.S. Cl. 348/86; 348/E07.085

(57) ABSTRACT

A real time monitoring device includes a light source, a screen, a camera module, and a processor. The light source emits incident light beams to a micro structure of a preprocessed workpiece to form a number of pre-compared diffraction light beams. The pre-compared diffraction light beams reach the screen to form a number of pre-compared light spots. The camera module captures the pre-compared light spots to obtain a pre-compared image having a zero order pre-compared dot and a number of non-zero order pre-compared dots. The processor stores a standard distance between a particular non-zero order standard dot and the zero order standard dot, and calculates a pre-compared distance between the zero order pre-compared dot and a particular non-zero order pre-compared dot, and calculates the difference value between the pre-compared distance and the standard distance to determine whether a blade processing the preprocessed workpiece is deviating in real time.

### BACKGROUND

1. Technical Field

The present disclosure relates to real time monitoring devices and, particularly, to a real time monitoring device for monitoring a working process of a manufacturing device.

2. Description of Related Art

A roller has a circumferential surface defining a number of micro units positioned densely and equidistantly. The micro units can be impressed on a pre-processed optical film to obtain a processed optical film. Therefore, the optical performance of the processed optical film depends on the precision of the micro units. In related art, the precision of the micro units is only tested after the manufacture of the roller, thus bad rollers will have to be discarded, which is a waste and the product cost will be increased.

Therefore, it is desirable to provide a real time monitoring device that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a real time monitoring device, according to an exemplary embodiment, wherein the real time monitoring device is configured for monitoring a manufacturing process of a preprocessed workpiece to obtain a processed workpiece.

FIG. 2 is a partial cross-sectional view of a processed workpiece taken along a rotating axis of the processed workpiece.

FIG. 3 is a schematic view of light trace of the real time monitoring device of FIG. 1.

FIG. 4 is a functional block diagram of a processor of the real time monitoring device of FIG. 1.

FIG. 5 is a schematic view of another real time monitoring device, the structure of which is substantially the same as the structure of the real time monitoring device of FIG. 1.

FIG. 6 is a schematic view of geometric triangles of diffraction light beams.

### DETAILED DESCRIPTION

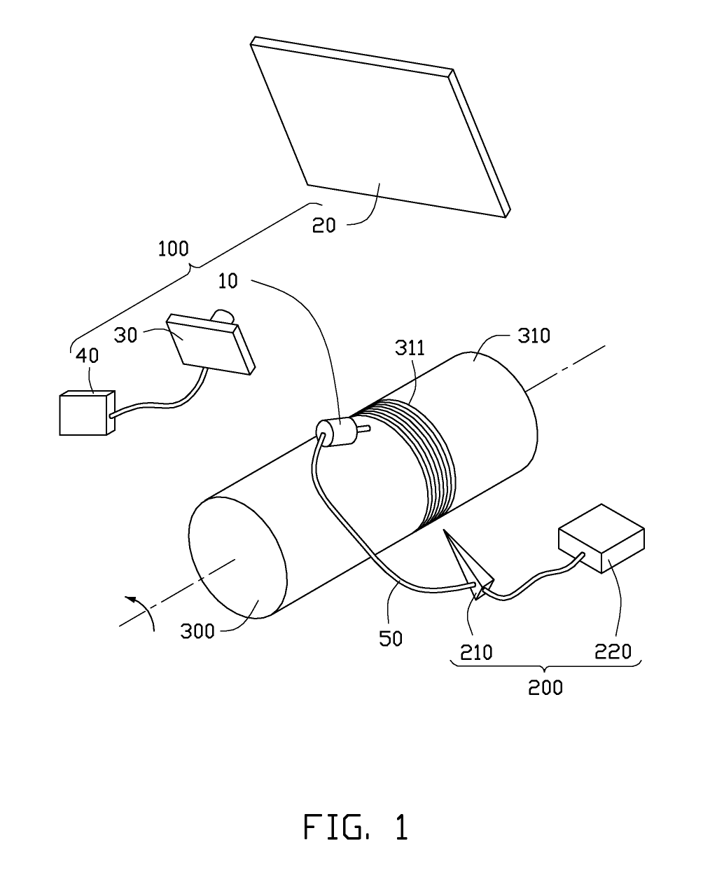

FIG. 1 illustrates a real time monitoring device 100 in accordance with an exemplary embodiment. The real time monitoring device 100 is used for monitoring a working process of a manufacturing device 200 when a preprocessed workpiece 300 is being manufactured by the manufacturing device 200.

The manufacturing device 200 includes a blade 210 and a controller 220. The blade 210 is used for creating a micro-structure 311 on the preprocessed workpiece 300. The controller 220 is used for controlling a moving direction, a moving distance, and a cutting depth of the blade 210. In this embodiment, the preprocessed workpiece 300 is a roller, the micro structure 311 includes a number of ring-shaped periodic micro units (i.e. micro grooves) 311a around a circumferential surface 310 of the preprocessed workpiece 300. The micro units 311 are densely and equidistantly positioned, and are parallel with each other, and thus form a diffraction grating. A central axis of each micro structure 311 coincides with a rotating axis of the preprocessed workpiece 300.

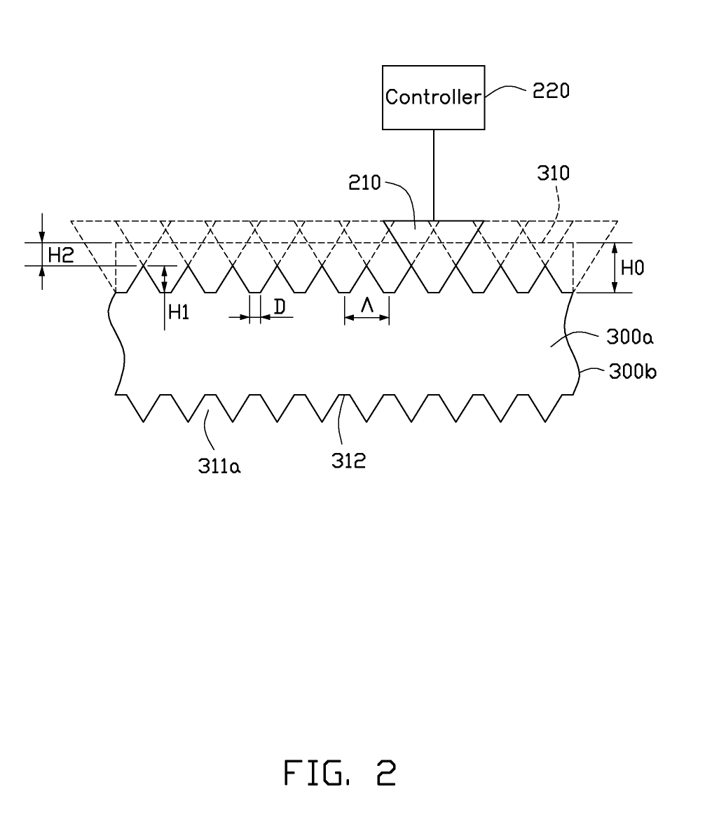

Also referring to FIG. 2, a lengthwise cross-sectional surface 300a of a processed workpiece 300b is shown. The cross-sectional surface 300a is an inverted trapezoid. A moving trace of the blade 210 is shown as broken lines. The manufacturing process of the manufacturing device 200 is as follows: the preprocessed workpiece 300 rotates, the controller 220 controls the blade 210 to move towards the circumferential surface 310 until the blade 210 cuts into the circumferential surface 310 to a desired depth H0. When a micro unit 311a is formed, the controller 220 controls the blade 210 to move off the preprocessed workpiece 300, then to move a predetermined distance A along the axis of the preprocessed workpiece 300, and then move in towards the circumferential surface 310 until the blade 210 again cuts into the circumferential surface 310 to the desired depth H0 to form another micro unit 311a. Λ is a distance between the middle points of each two adjacent micro units 311a, that is, Λ is a periodicity of the micro structure 311. H1 is the depth of each micro unit 311, H2 is the depth of the preprocessed workpiece 300 cut by the blade 210, therefore, H0=H1+H2. D is a width of the flat bottom surface 312 of each micro unit 311a.

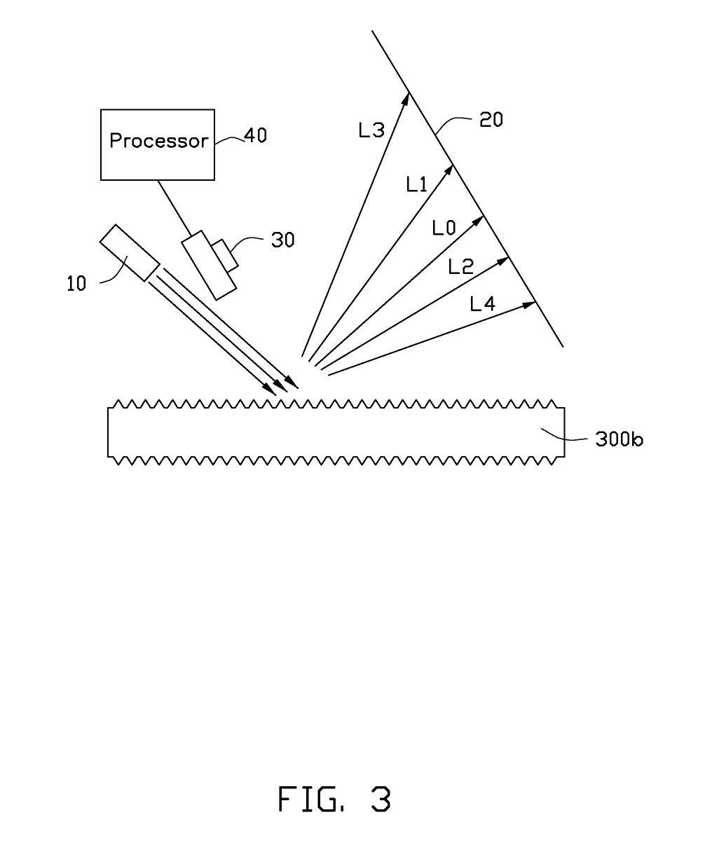

Referring to FIGS. 1 and 3, the monitoring device 100 includes a light source 10, a screen 20, a camera module 30, and a processor 40.

The light source 10 emits a number of parallel incident light beams onto the circumferential surface 310 at a predetermined incident angle. The light source 10 is fixedly connected to the blade 210 through a connecting device 50, and moves with the blade 210, therefore, the light source 10 is unmoving with respect to the blade 210, and incident angles are changeless even though the blade 210 moves. In this embodiment, the light source 10 is a laser source (such as a helium-neon laser).

Incident light beams from the light source 10 reach a number of continuous micro units 311a to form a number of pre-compared diffraction light beams L0, L1, L2, L3, and L4. The middle pre-compared diffraction light beam L0 is a zero order pre-compared diffraction light beam, L1 is a positive first order pre-compared diffraction light beam, L2 is a negative first order pre-compared diffraction light beam, L3 is a positive second order pre-compared diffraction light beam, and L4 is a negative second order pre-compared diffraction light beam. The zero order pre-compared diffraction light beam L0 reaches the screen 20 to form a zero order pre-compared light spot, the four non-zero order pre-compared diffraction light beams L1, L2, L3, and L4 reach the screen 20 to form four non-zero order pre-compared light spots.

The camera module 30 captures the pre-compared light spots to obtain a pre-compared image. The pre-compared image includes a zero order pre-compared dot and a number of non-zero order pre-compared dots. The zero order pre-compared dot corresponds to the zero order pre-compared light spot. The non-zero order pre-compared dots correspond to the non-zero order pre-compared light spots.

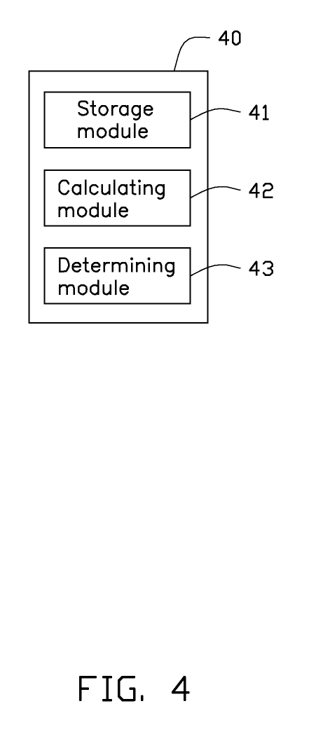

The processor 40 is electrically connected to the controller 220, and is used for determining whether the blade 210 is deviating in real time, and calculating the current deviation distance of the blade 210. Referring to FIG. 4, the processor 40 includes a storage module 41, a calculating module 42, and a determining module 43.

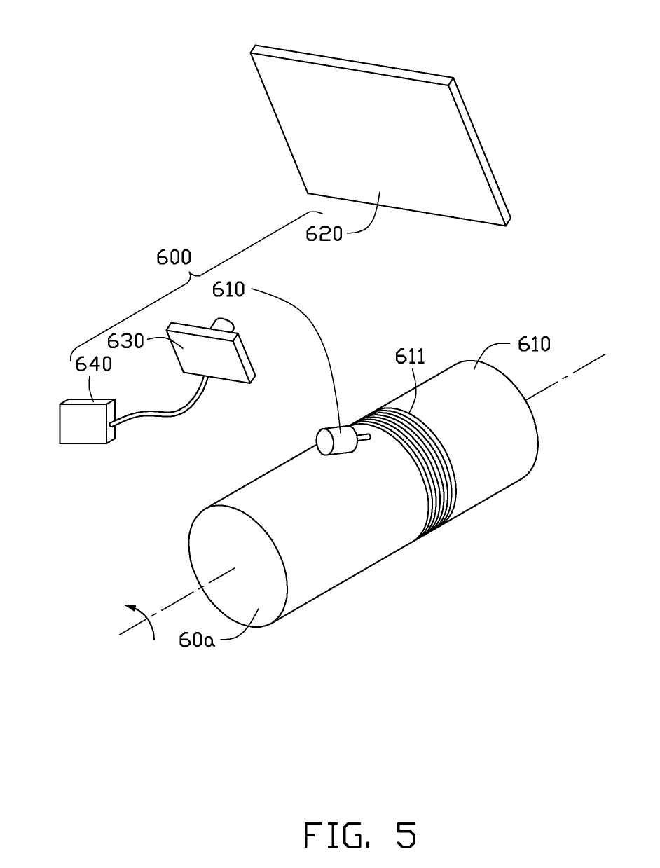

Also referring to FIG. 5, the storage module 41 stores a standard image which has a zero order standard dot and a number of non-zero order standard dots. The standard image is obtained as follows: a standard workpiece 60a is provided and is mounted on another real time monitoring device 600, the structure of which is substantially the same as the structure of the real time monitoring device 100. The monitoring device 600 includes a light source 610, a screen 620, a camera module 630, and a processor 640. A circumferential surface 611 of the standard workpiece 60a has been defined a number of standard micro units 611, incident light beams reach a number of continuous standard micro units 611 to form a number of standard diffraction light beams, the standard diffraction light beams reach a screen to form a number of standard light spots, the camera module 630 captures the standard light spots to obtain the standard image.

The storage module 41 further stores a standard distance between the zero order standard dot and a particular non-zero order (e.g. positive first order) standard dot.

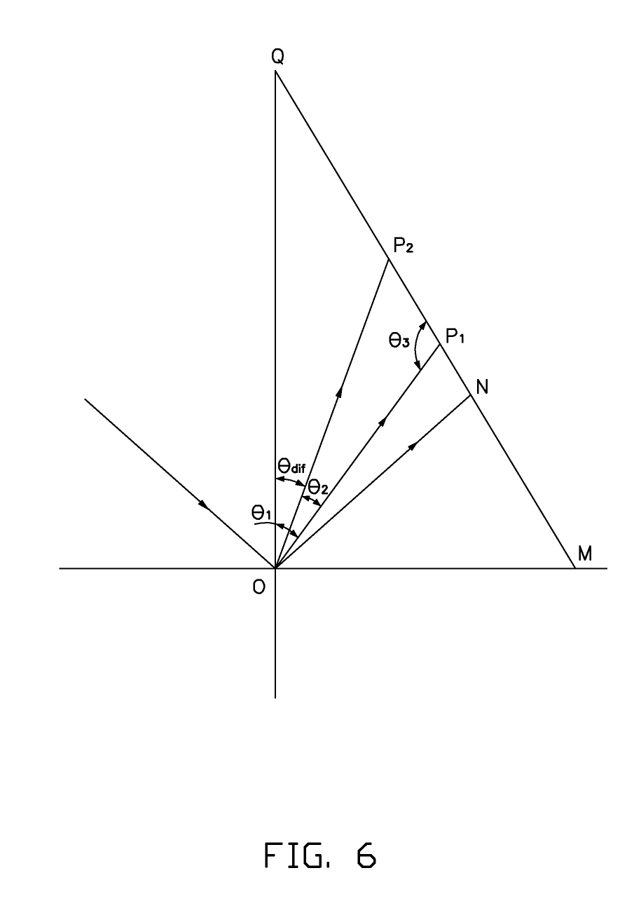

Referring also to FIG. 6, according to the diffraction grating law mλ=Λ(n₂ sin θ_{dif}−n₁ sin θ_{inc}), wherein m is an order number, Λ is the periodicity of the micro structure, n1 is a refractive index of the medium where incident light beams are transmitted, θ_{inc} is an incident angle of the incident light beams (i.e. the angle between the incident light beams and a normal line of the circumferential surface 310), n2 is a refractive index of the medium where the diffraction light beams are transmitted, and θ_{dif} is a diffraction angle of a particular one of the diffraction light beams (i.e. the angle between the particular one of the diffraction beams and the normal line of the circumferential surface 310). The diffraction angles of the diffraction light beams are all different.

Because both of the incident light beams and the diffraction light beams transmitted in the air, therefore, n₁=n₂=1. Because the light source 10 moves along the rotating axis of the workpiece 300, and the workpiece is cylindrical, the incident angles of the incident light beams θ_{inc} are therefore changeless. When m=0, θ_{dif}=θ_{inc}. Because the incident angle of the incident light beams on the continuous standard micro units is substantially the same as the incident angle of the incident light beams on the continuous pre-compared micro units, therefore, the diffraction angle of the zero order standard diffraction light beams is substantially the same as the diffraction angle of the zero order pre-compared diffraction light beams, that is, the location of the zero order standard dot in the standard image is substantially the same as the location of the zero order pre-compared dot in the pre-compared image.

The calculating module 42 receives the pre-compared image, and calculates a pre-compared distance between the zero order pre-compared dot and the particular non-zero order (e.g. positive first order) pre-compared dot in a same order as the order of the particular non-zero order standard dot, and further calculates the difference value between the pre-compared distance and the standard distance. If the difference value is substantially equal to zero, then the determining module 43 determines that the blade 220 is not deviating in real time. If the difference value is not substantially equal to zero, then the determining module 43 determines that the blade 220 is deviating in real time.

The calculating module 42 further calculates the current deviation value of the blade 210 according to the difference value when the difference value is not substantially equal to zero.

The calculating module 42 firstly calculates a pre-determined proportion value by dividing a first standard distance between the zero order standard light spot and the particular non-zero order (e.g. positive first order) standard light spot by a second standard distance between the zero order standard dot and the particular non-zero order (e.g. positive first order) standard dot; and secondly calculates an actual difference value between the pre-compared light spot and the standard light spot by multiplying the calculated difference value by the pre-determined proportion value; and thirdly calculates θ_{dif} according to the actual difference value and geometric triangle formulas, and fourthly takes the θ_{dif} into the diffraction law to obtain the current periodicity, and finally subtracts the standard periodicity from the current periodicity to obtain the current deviation value.

In particular, the calculating process of θ_{dif} is as follows: because an illumination range of the incident light beams on the circumferential surface 310 is very small relative to the length of the screen 20, then a cross portion between the incident light beams and the circumferential surface 310 can be treated as a cross point. Referring to FIG. 5, point O represents the cross point of the incident light beams and the circumferential surface 310, line OM represents the circumferential surface 310, line MQ represents the screen 20, line OQ represents the normal line of the circumferential surface 310, line ON represents the zero order standard diffraction light beams, line OP₁ represents the first order standard diffraction light beams, line OP₂ represents the first order pre-compared diffraction light beams, θ₁ represents the diffraction angle of the first order standard diffraction light beams, θ₂ represents an angle between the first order standard diffraction light beams and the first order pre-compared diffraction light beams, θ₃ represents an angle between the screen and the first order standard diffraction light beams, and θ_{dif} represents the diffraction angle of the first order pre-compared diffraction light beams. In geometric triangle OP₁P₂, the length of line OP₁ and the angle of θ₃ can be measured, the length of line P₁P₂ has been calculated by the calculating module 42, and θ₂ can be calculated using geometric triangle formulas according to θ_{dif}=θ₁−θ₂ and then θ₁ can be calculated by the diffraction law, and thus θ_{dif} can be obtained.

The controller 220 adjusts the moving distance of the blade 210 according to the calculated current deviation value.

By employing the real time monitoring device 100, the working process of the blade 210 can be monitored in real time, and thus the controller 220 can constantly adjust the moving of the blade 210, the overall precision of the processed workpiece 300a will be acceptable, and the product cost reduced.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A real time monitoring device for monitoring a process of processing a preprocessed workpiece by using a blade, the blade being for processing a plurality of continuous pre-compared micro units on the preprocessed workpiece, the real time monitoring device comprising:
a light source configured for emitting incident light beams on the continuous pre-compared micro units to form a plurality of pre-compared diffraction light beams;
wherein the light source is unmoving relative to the blade, and the diffractive light beams comprises a zero order pre-compared diffractive light beam and a plurality of non-zero order pre-compared diffractive light beams;
a screen configured for receiving the pre-compared diffraction light beams to form a plurality of pre-compared light spots; wherein the pre-compared light spots comprises a zero order pre-compared light spot corresponding to the zero order pre-compared diffractive light beam and a plurality of non-zero order pre-compared light spots corresponding to the non-zero order pre-compared diffractive light beams;
a camera module configured for capturing the pre-compared light spots to obtain a pre-compared image, wherein the pre-compared image has a zero order pre-compared dot corresponding to the zero order pre-compared light spot and a plurality of non-zero order pre-compared dots corresponding to the non-zero order pre-compared light spots; and
a processor storing a standard distance between a zero order standard dot and a particular non-zero order standard dot, the processor configured for receiving the pre-compared image, and calculating a pre-compared distance between the zero order pre-compared dot and a particular one of the non-zero order pre-compared dots according to the pre-compared image, the particular non-zero order pre-compared dot being in the same order as the particular non-zero order standard dot, the processor further configured for calculating the difference value between the pre-compared distance and the standard distance to determine whether the blade is deviating in real time.

2. The real time monitoring device of claim 1, wherein the processor comprises a storage module, a calculating module, and a determining module, the storage module is configured for storing the standard distance between the zero order standard dot and the particular non-zero order standard dot; the calculating module is configured for receiving the pre-compared image, calculating the pre-compared distance between the zero order pre-compared dot and the particular non-zero order pre-compared dot the order of which is same as the order of the particular non-zero order standard dot, and further calculating the difference value between the pre-compared distance and the standard distance; the determining module is configured for determining whether the blade is deviating in real time according to the difference value.

3. The real time monitoring device of claim 2, wherein if the difference value is substantially equal to zero, the determining module determines that the blade is not deviating in real time, if the difference value is not substantially equal to zero, the determining module determines that the blade is deviating in real time.

4. The real time monitoring device of claim 3, wherein the blade is controlled by a controller, the calculating module is configured for calculating a current deviation distance of the blade when the difference value is not substantially equal to zero, and the controller is configured for adjusting the movement of the blade according to the current deviation distance.

5. The real time monitoring device of claim 4, wherein the light source is fixedly connected to the blade through a connecting device, and thus the light source is unmoving relative to the blade.

6. The real time monitoring device of claim 4, wherein the processor stores a standard image having the zero order standard dot and a plurality of non-zero order standard dots, and the non-zero order standard dots comprise the particular non-zero order standard dot.

7. The real time monitoring device of claim 6, wherein the standard image is obtained as follows: a standard workpiece is provided and is mounted on another real time monitoring device, the structure of which is substantially the same as the structure of the real time monitoring device, the another monitoring device includes a light source, a screen, a camera module, and a processor, a circumferential surface of the standard workpiece has been defined a plurality of standard micro units, incident light beams reach a plurality of continuous standard micro units to form a plurality of standard diffraction light beams, the standard diffraction light beams reach a screen to form a plurality of standard light spots, the camera module captures the standard light spots to obtain the standard image.

8. The real time monitoring device of claim 7, wherein the calculating module firstly calculates a pre-determined proportion value by dividing a first standard distance between the zero order standard light spot on the screen of the another real time monitoring device and a particular non-zero order standard light spot on the screen of the another real time monitoring device by a second standard distance between the zero order standard dot and the particular non-zero order standard dot; and secondly calculates an actual difference value between a particular non-zero order pre-compared light spot and a particular standard light spot by multiplying the calculated difference value by the pre-determined proportion value; and thirdly calculates θ_{dif} according to the actual difference value and geometric triangle formulas, and fourthly takes the θ_{dif} into the diffraction law mλ=Λ(n₂ sin θ_{dif}−n₁ sin θ_{inc}) to obtain the current periodicity, and finally subtracts the standard periodicity from the current periodicity to obtain the current deviation value, wherein m is an order number, n1 is a refractive index of the medium where the pre-compared incident light beams are transmitted, θ_{inc} is an incident angle of the incident light beams, n2 is a refractive index of the medium where the pre-compared diffraction light beams are transmitted, and θ_{dif} is a diffraction angle of a particular one of the diffraction light beams.
